(19) United States
(12) Patent Application Publication
(10) Pub. No.: US 2023/0022480 A1
(43) Pub. Date: Jan. 26, 2023

(54) Crumbler Basket Implement

(71) Applicant: Daniel Wayne Chupp, Quinter, KS (US)

(72) Inventor: Daniel Wayne Chupp, Quinter, KS (US)

(21) Appl. No.: 17/871,923

(22) Filed: Jul. 23, 2022

Related U.S. Application Data
(60) Provisional application No. 63/225,298, filed on Jul. 23, 2021.

(51) Int. Cl. A01B 29/04

(52) U.S. Cl. CPC A01B 29/048

(57) ABSTRACT

A crumbler basket implement includes a frame having at least two side by side segments and a plurality of generally cylindrical crumbler baskets. Each crumbler basket include opposite end plates that have diameters that are substantially less than the diameter of the crumbler basket. Each crumbler basket is also canted at an acute angle with respect to the transverse direction of the implement. The crumbler baskets are preferably arranged so that the forward leading end of a basket is situated to be in front of the rearward trailing end of the next adjacent basket. Preferably, the crumbler baskets are also arranged so that approximately equal numbers of crumbler baskets are slanted in opposite directions to balance side forces in the implement.

### CROSS REFERENCES TO RELATED APPLICATIONS

This application claims the benefit of U.S. Provisional Patent Application 63/225,298 filed on Jul. 23, 2021, which is incorporated herein by reference in its entirety.

### FIELD

This invention relates to implements that include crumbler baskets.

### BACKGROUND

A crumbler basket is a type of attachment that is typically mounted to the back of a cultivating implement. Usually a set of crumbler basket assemblies are attached in an overlapping or staggered pattern to the back of a cultivating implement. Typically, a crumbler basket assembly will include a crumbler basket which includes a cylindrical pattern of splines that are fixed to end plates and supported by intermediate support plates. The end plates are rotatably mounted to a yoke that, in turn, is at least indirectly fixed to the implement. The baskets are pulled by the implement so that they roll over farm ground to disrupt weeds and to smooth the ground. Prior art crumbler baskets have been oriented perpendicular to the path of travel of the implement. Typically, the implement has a segmented frame. The segments are supported by wheels and are arranged from side to side and the frame segments are interconnected at pivot joints in order to allow the segments pivot as they follow left to right contour variations.

Crumbler baskets can be effective for smoothing ground and disrupting weeds. The disruption of weeds is especially evident if a set of crumbler baskets is mounted behind a sweep plow implement as described in U.S. Pat. No. 10,178,824 which was issued on Jan. 15, 2019 and which is incorporated herein by reference. A sweep plow implement is effective for cutting the roots of weeds and a set of crumbler baskets that follow behind a sweep plow can be effective for pulling and disrupting weeds that have been cut by the sweep plow. However, the prior art perpendicular arrangement of crumbler baskets presents problems for operators. Conventional crumbler baskets when oriented perpendicular to the direction of travel tend to accumulate dirt clods and plant material requiring periodic removal of such materials and conventional, prior art crumbler baskets may not fully disrupt and kill weeds. And, prior art crumbler basket tend to leave ridges at their ends as the roll over farm ground.

### SUMMARY

The present invention is a crumbler basket arrangement that addresses the above described problems and also provides other advantages. The crumbler basket arrangement includes a set of crumbler baskets that are mounted to an implement. Typically, the implement includes a frame that has a plurality of side by side segments and is supported by wheels. The implement may be a stand-alone implement exclusively for carrying crumbler baskets, or the set of crumbler baskets may be mounted to the back end of an implement that carries other equipment for cultivating farm ground. Each crumbler basket includes opposite end plates having a first diameter. A plurality of elongated spline members each have symmetrically inwardly directed ends that are directed radially inward with a inwardly curved or inwardly angled end portion such that each of the ends are fixed to one of the opposite end plates. The spline members define an elongated cylindrical cage. The outside diameter of the cylindrical cage is a second diameter that is substantially larger than the first diameter of the end plates. A yoke spans around the crumbler basket and rotatably engages the end plates to permit rolling movement of the crumbler basket. The yoke includes provisions for fixing the crumbler basket assembly to an implement frame. The crumbler baskets are arranged in a generally parallel pattern. Each crumbler basket is canted or angled at an acute angle with respect to the transverse direction. The acute mounting angle is preferably between five and thirty angular degrees and is most preferably between twenty and thirty degrees. The crumbler baskets are preferably arranged so that the forward leading end of a basket is situated to be in front of the rearward trailing end of the next adjacent basket. This canted or angled orientation with respect to the direction of travel allows for increased spacing between the splines, which, in turn, facilitates the ejection of material from the basket and prevents accumulation of material within the basket. Moreover, increased spline spacing and the slanted or canted orientation causes the crumbler basket to disrupt and displace weeds in a sideways direction. Still further, the overlapping configuration eliminates furrowing at the ends of the baskets and results in a very smooth soil surface after the crumbler baskets have passed over the farm ground. It is also advantageous to balance any side forces by arranging a set of crumbler baskets so that roughly half of the crumbler baskets are oriented with the right end forward of the left end and such that approximately the other half are oriented with the left end forward of the right end.

### BRIEF DESCRIPTION OF THE DRAWINGS

FIG. 1 is a perspective view of a first embodiment of an implement that includes crumbler basket assemblies.

FIG. 2 is a plan view the first embodiment of an implement that includes crumbler basket assemblies.

FIG. 3 is a perspective view of a second embodiment of an implement that includes crumbler basket assemblies.

FIG. 4 is a plan view of the second embodiment of an implement that includes crumbler basket assemblies.

FIG. 5 is a perspective view of one embodiment of a crumbler basket assembly.

FIG. 6 is a side view of one embodiment of a crumbler basket assembly.

FIG. 7 is a bottom view of one embodiment of a crumbler basket assembly.

FIG. 8 is an end view of one embodiment of a crumbler basket assembly.

FIG. 9 is a perspective view of a second embodiment of a crumbler basket assembly.

FIG. 10 is a side view of a second embodiment of a crumbler basket assembly.

FIG. 11 is a bottom view of a second embodiment of a crumbler basket assembly.

FIG. 12 is a perspective view of a third embodiment of an implement that is exclusively a crumbler basket implement.

FIG. 13 is a plan view of the third embodiment of an implement that is exclusively a crumbler basket implement.

### DETAILED DESCRIPTION

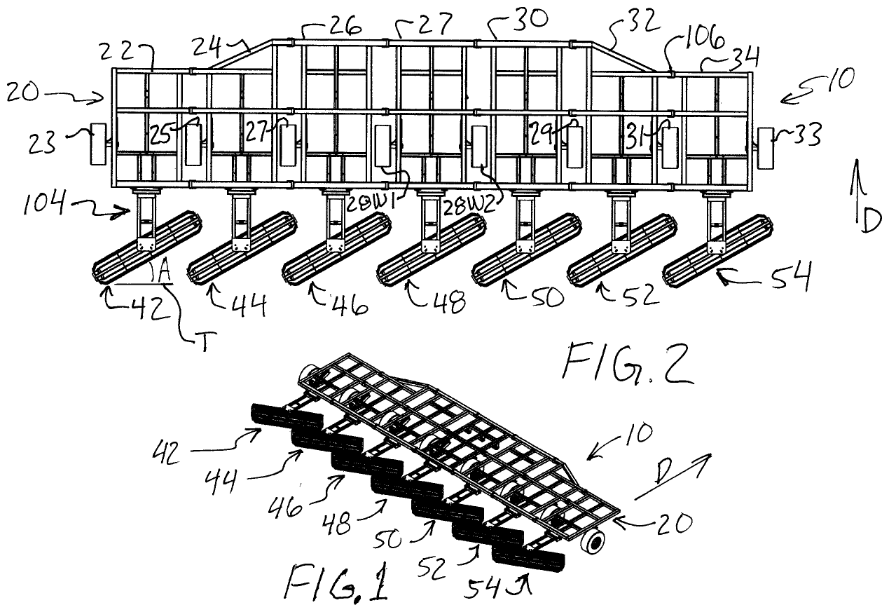

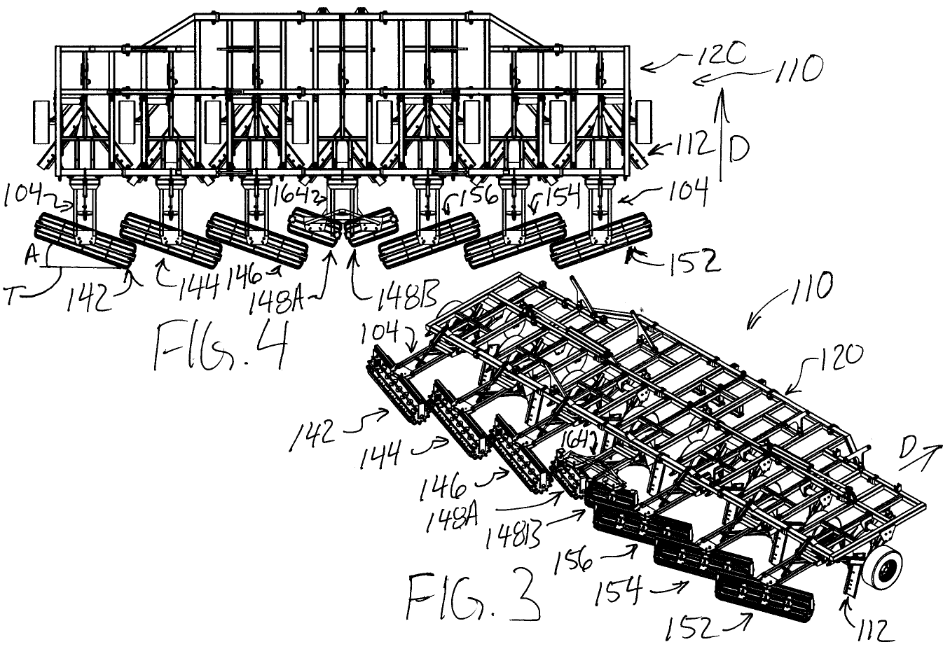

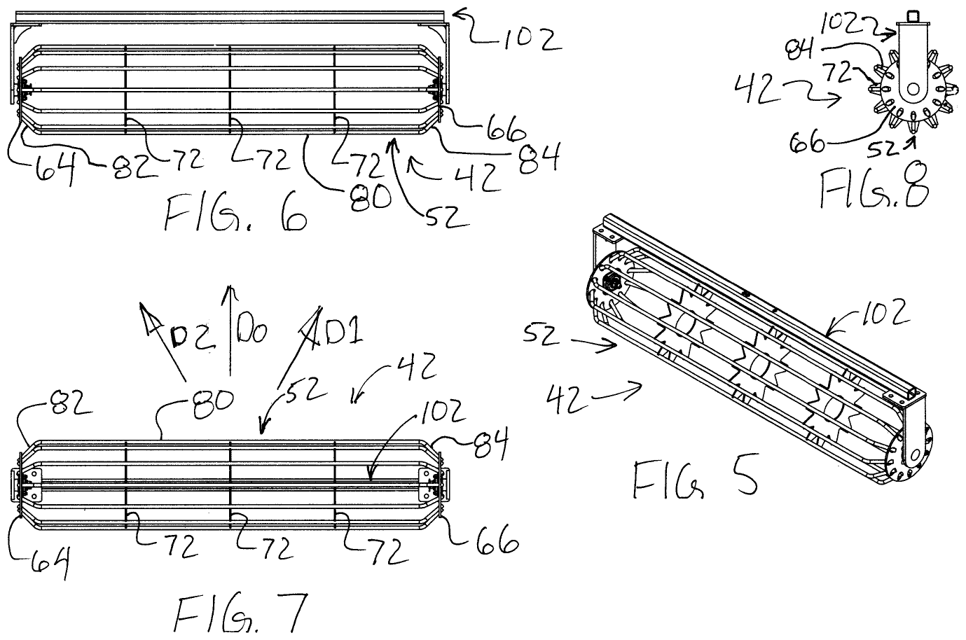

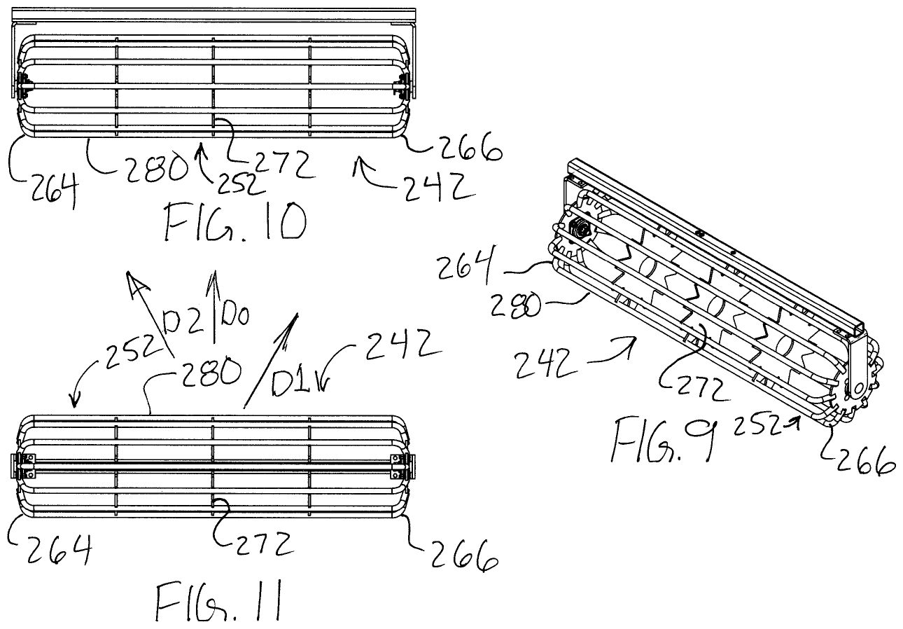

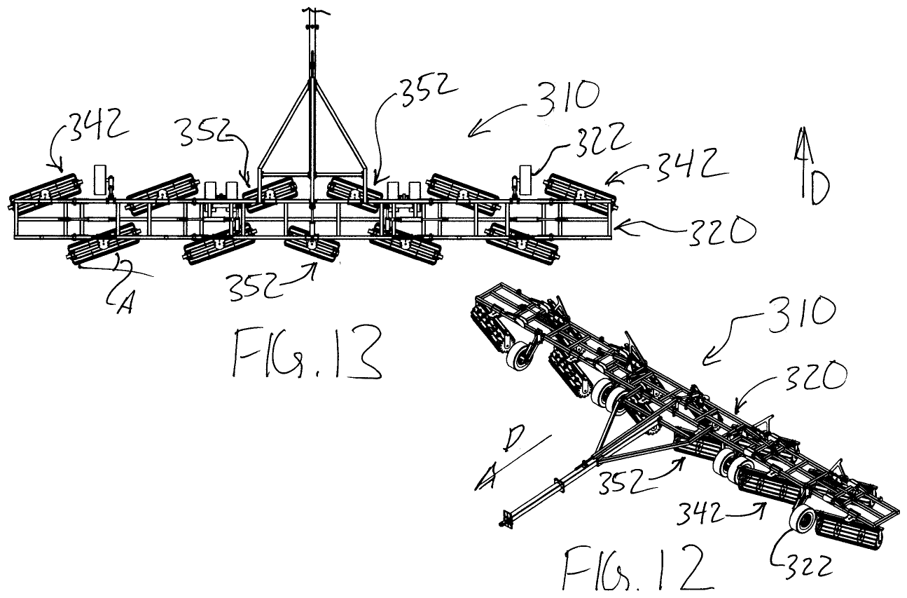

Referring to FIG. 1, an implement 10 is shown to include a frame 20 which includes a plurality of side by side frame segments 22, 24, 26, 28, 30, 32 and 36 , wheel assemblies 28W1, 28W2, 23, 25, 27, 29, 31 and 33 and crumbler basket assemblies 42, 44, 46, 48, 50, 52 and 54. Center frame segment 28 is supported by wheel assemblies 28W1 and 28W2. The other frame segments, namely frame segments 22, 24, 26, 30, 32 and 36 are supported by wheel assemblies 23, 25, 27, 29, 31 and 33 respectively. Direction arrows D in FIGS. 1 and 2 indicate the usual direction of travel for implement 10. In this example, crumbler basket assemblies 42, 44, 46, 48, 50, 52 and 56 are attached to the back ends of frame segments 22, 24, 26, 28, 30, 32 and 36 respectively. Frame segments 22, 24, 26, 28, 30, 32 and 36 are jointed together by pivot joints (such as pivot joint 106 indicated in FIG. 2) in order to pivot with respect to one another about longitudinal axes in order to accommodate side to side variations in contour. As can be seen in FIG. 2, crumbler basket assemblies 42, 44, 46, 48, 50, 52 and 54 are all canted at an acute angle A with respect to the transverse direction T. And, each crumbler basket overlaps in the transverse direction with the next basket on its right. In this example, the angle of slant is 30 degrees but that angle could be between 5 and 35 degrees with an angle between 20 and 30 degrees being preferred.

Implement 10 may also be understood as an implement having a frame 20 to which is mounted other cultivating elements that are mounted forward of the crumbler basket assemblies shown in FIGS. 1 and 2. Such other cultivating elements may include sweep plows or other types of cultivating hardware. Thus, the skilled reader may understand that FIGS. 1 and 2 omit such other cultivating elements for clarity and simplicity of illustration. In the case of such an implement, crumbler basket assemblies, 42, 44, 46, 48, 50, 52 and 56 may be understood as attachments that are added to the back of implement 10 as shown in FIGS. 1 and 2. Optionally, a stand-alone implement may also be configured that supports only crumbler baskets. However, such a stand-alone crumbler basket implement would likely need a frame that could be less extensive than frame 20 shown in FIGS. 1 and 2.

The applicant has learned through research and development efforts that while it may be possible to operate a set of crumbler basket assemblies that are configured as shown in FIGS. 1 and 2, significant side forces do result if all of the crumbler basket assemblies are oriented in the same direction. In FIGS. 1 and 2, all of the crumbler baskets are oriented so that the left end of the crumbler basket is farther back than the right end of the crumbler basket. Accordingly, a preferred approach is to have the crumbler basket assemblies angled so that approximately half are oriented with the right end farther forward than the left and approximately the remaining half are oriented with the left end farther forward of the right end. This is the case for implement 110 shown in FIGS. 3 and 4 which will be described in further detail below and also generally the case for stand-alone implement 310 shown in FIGS. 12 and 13 which will also be described in further detail below.

FIGS. 3 and 4 show a second embodiment of an implement 110 having a frame 120 to which are mounted crumbler basket assemblies 142, 144, 146, 152, 154, 156, 148A and 148B. Direction arrows D in FIGS. 3 and 4 indicate the direction of travel for implement 110. As was the case with implement 10, implement 110 may be an implement that carries cultivating elements forward of the crumbler basket assemblies. FIGS. 3 and 4 illustrate an implement 110 that carries sweep plows 112 of the type shown and described in U.S. Pat. No. 10,178,824 noted above. The present crumbler basket assemblies are particularly effective when pulled behind sweep plows such as sweep plows 112. Sweep plows 112 are adapted for cutting under roots and the present crumbler baskets are particularly effective for disrupting and scattering the weeds that have been cut. As was the case with frame 20 described above, frame 120 also has frame segments that are joined together by pivot joints (such as pivot joint 106 indicated in FIG. 2) in order to pivot with respect to one another about longitudinal axes in order to accommodate side to side variations in contour. Still further, a crumbler basket assembly such as crumbler basket assembly 142 should be understood as substantially identical to crumbler basket assemblies 144, 146, 152, 154, 156 of implement 110 as well as crumbler basket assemblies 42, 44, 46, 48, 50, 52 and 56 of implement 10. Even crumbler basket assemblies 148A and 148B only vary in overall length from the other crumbler basket assemblies in the set.

As can be best seen in FIG. 4, crumbler basket assemblies 142, 144, 146, 152, 154, 156, 148A and 148B of implement 110 are arranged in a symmetrical inwardly slanting pattern which is arranged to balance side forces. Accordingly, crumbler basket assemblies 142, 144, and 146 are arranged in a slanting, overlapping pattern such that outboard ends of each crumbler basket assembly is spaced farther away from frame 120 than the inboard end of each crumbler basket assembly and overlaps in the transverse direction with the next inboard crumbler basket assembly. Further, the inboard end of each of crumbler basket assembly 142 and 144 is positioned forward of the outboard end of the next adjacent crumbler basket assembly. A similar symmetrical arrangement is followed on the opposite side. Crumbler basket 152, like crumbler basket 142, is located at the outboard end of frame 120. The outboard end of crumbler basket assembly 152 is spaced farther away from frame 120 than its inboard end. The same is true for crumbler basket assemblies 154 and 156 so that crumbler basket assemblies 152, 154 and 156 present an overlapping, slanted pattern that is symmetrical to the pattern presented by crumbler basket assemblies 142, 144 and 146 on the opposite side of implement 110. Crumbler basket assemblies 148A and 148B are shorter in length than crumbler basket assemblies 142, 144, 146, 152, 154 and 156. Crumbler basket assembly 148A is slanted in a fashion similar to crumbler basket assemblies 142, 144 and 146 so that its outboard end overlaps the inboard end of crumbler basket 146. Crumbler basket assembly 148B is oriented so that its inboard end overlaps with the inboard end of crumbler basket assembly 148A and so that its outboard end is behind and overlaps with the inboard end of crumbler basket assembly 156. Thus, crumbler basket assemblies 142, 144, 146, 152, 154, 156, 148A and 148B are arranged so that the crumbler basket assemblies cover all of the ground behind implement 110 and so that all of the side forces that result from the slanted orientation of the crumbler basket assemblies are balanced and therefore yield a transverse force that is at or near zero. The degree of slanting or canting is indicated in FIG. 4 as angle A which is the angle between the implement's transverse direction T and the axis of the crumbler basket of crumbler basket 142 as well as the other crumbler baskets.

If a set of crumbler basket assemblies are arranged in a slanted pattern as describe above, it is necessary to employ specialized crumbler baskets that are adapted for being oriented at an acute angle or canted angle with respect to a transverse or normal orientation. For clarity and simplicity, crumbler basket assembly 42 which is mounted to frame segment 22 of implement 10 will be described. The skilled reader should understand that a crumbler basket assembly 142 is substantially identical to crumbler basket assembly 42. Moreover, crumbler basket assembly 242 is also very similar to crumbler basket assembly 42 and only differs in minor respects as is discussed below. Still further, it should be understood that shorter versions of the crumbler basket assemblies, such as crumbler basket assemblies 148A and 148B of implement 110 are generally identical in design but merely differ in length. Still further crumbler basket assemblies 342 and 352 shown in FIGS. 12 and 13 for stand-alone implement 310, which will be discussed below, differ only with respect to overall size as will be further discussed below. The skilled reader should understand that all of the other crumbler basket assemblies may be considered as being substantially similar to crumbler basket assembly 42 shown in FIGS. 5-8.

As is shown in FIGS. 5 -8, crumbler basket assembly 42 includes a crumbler basket 52 that is rotatably mounted to a yoke 102. Crumbler basket 52 further includes end plates 64 and 66, three intermediate support plates 72 and a plurality of elongated spline members 80. Intermediate support plates 72 are star shaped and have central openings. Each point of each star of each intermediate support plate 72 is fixed (preferably by weldments) to an elongated spline member 80. Each spline member 80 has symmetrically inwardly directed ends 82 and 84. End plates 64 and 66 each have a substantially smaller diameter than crumbler basket 52. Inwardly directed ends 82 and 84 of each spline member 80 are fixed (preferably by weldments) to the outer edges of end plates 64 and 66 respectively.

As can be seen in FIGS. 5-8, spline members 80 are distributed in an evenly spaced manner such that they define an elongated cylindrical basket 52. Yoke 102 spans around crumbler basket 52 and rotatably engages each end plates 64 and 66. Yoke 102 includes provisions for mounting to a basket mount structure such as basket mount structure 104 that projects from the back of each frame segment (22, 24, 26, 28, 30, 32 and 36) as shown in FIG. 1 and also as shown in FIG. 4. The connection between yoke 102 and basket mount structure 104 needs to be fixed so as to prevent rotation of crumbler basket assembly 42 about a vertical axis.

As noted above, crumbler basket 42 shown in FIGS. 5-8 and crumbler basket assembly 242 shown in FIGS. 9-11 are generally very similar. However, the curved ends of splines 280 of basket 252 shown in FIGS. 9-11 are believed to be an improvement over the angled spline ends of basket 52 shown in FIGS. 5-8. However, both crumbler basket 52 shown in FIGS. 5-8 and crumbler basket 252 shown in FIGS. 9-11 differ from prior art crumbler baskets in three important respects. First, crumbler baskets 52 and 252 have end plates that are significantly smaller in diameter than the overall diameter of the crumbler basket. Secondly, the splines of crumbler baskets 52 and 252 either angle in toward the end plate at both ends as is the case with crumbler basket 52 or curve in toward those end plates at both ends as is the case with crumbler basket 252. And thirdly, the splines of crumbler baskets 52 and 252, in this example, are spaced every 30 degrees or approximately 4 to 5 inches apart in the case of a crumbler basket having a diameter of about 18 inches. This spacing is substantially wider than is the case with most conventional prior art crumbler baskets. The canted orientation of the crumbler basket assemblies of the implement arrangements shown in FIGS. 1, 2, 3, 4, 12 and 13 would result in significant furrows and adjacent ridges if the end plates of the crumbler baskets had conventional full diameters. Moreover, it is possible to widely space the splines at 4 to 5 inches in crumbler baskets 52 and 252 because widely spaced splines are as effective if not more effective when the crumbler basket is canted than is the case with narrowly space splines of a conventional prior art non-canted crumbler basket. The applicant has observed that when crumbler baskets of this type which are arranged in an angled pattern, as shown in FIGS. 1-4 and FIGS. 12 and 13, are pulled over farm ground, the baskets pick up weeds, push them in a sideways direction and then eject them in a condition that renders them incapable of re-rooting and surviving.

Crumbler basket 52 and crumbler basket 252 may preferably have an overall diameter of between 15 and 20 inches and a length of 70 to 80 inches. In the examples shown in FIGS. 1-4, 18 inches was selected for the diameter and 78 inches was selected for the length, with the exception of crumbler basket assemblies 148A and 148B shown in FIGS. 3 and 4, which were significantly shorter at 48 inches. In the examples shown in FIGS. 5-11, the crumbler baskets depicted were 18 inches in diameter and have 12 evenly spaced splines which are arranged in a circular pattern and which all have a diameter of approximately 1 inch and are evenly spaced every 30 degrees and thus are approximately 4.4 inches apart from each other center to center. The splines of all of the crumbler baskets noted herein are preferably 1 inch in diameter. The end plates and the support plates (64, 66 and 72) may be fabricated from suitable steel plate having a thickness between ⅛ and ¼ inches. The end plates typically have a diameter that is about 70% of the overall diameter of the crumber basket. A typical basket assembly as described here in, namely basket assemblies 42 and 142 may weight approximately 500 lbs. These dimensions and other values are by no means specifically required to practice the invention and are given only by way of an example in order to describe an example crumbler basket configuration that has performed well in field tests.

FIGS. 12 and 13 illustrate an example of a crumbler basket implement 310 which is an implement that is arranged exclusively as a crumbler basket implement. As can be seen in FIGS. 12 and 13, crumbler basket implement 310 includes a frame 320 that is supported by a set of wheels 322. Two sets of four identical crumbler basket assemblies 342 are arranged symmetrically on both sides of frame 320.

The crumbler basket assemblies 342 on both sides slant back from inboard to outboard. The angle of slant A, in this example, is approximately 22 degrees, or between 20 and 25 degrees. As was the case with crumbler baskets mounted to implements 10 and 110, there is overlap between the outboard and inboard ends of adjacent crumbler baskets. Three crumbler baskets 352, which are shorter than crumbler baskets 342, are arranged near the center of implement 310. A first left side inboard crumbler basket 352 leads left inboard crumbler basket 342. In the same way, a first right side inboard crumbler basket 352 leads a right inboard crumbler basket 342. A center crumber basket 352 slants back from left to right and spans between the inboard ends of the other two crumbler baskets 352. This arrangement does result in a centrally mounted crumbler basket 352 that is slanted and not balanced by another crumbler basket that is slanted in an opposite direction. This would result in a force in the left direction as viewed in FIG. 13, but such a force would not be significant and would not effect the overall operation of implement 310. The crumbler baskets for crumbler basket implement 310 may be larger in size that the crumbler baskets employed for implements 10 and 110. The crumbler baskets of crumbler basket assemblies 342 may be approximately 24 inches in diameter and approximately 8 feet in length. The crumbler baskets of crumbler basket assemblies 352 may also be approximately 24 inches in diameter, but are shorter at approximately 5 feet in length. However, similar materials for the end plates and the splines as described above for crumbler baskets 52 and 252 may be used for basket assemblies 342 and 352.

The operation of implements having the present crumbler baskets attached as shown in FIGS. 1-4 and FIGS. 12 and 13, may be understood by referring to those figures as well as FIGS. 5-11. The implement is pulled by a tractor in the direction D as shown in FIGS. 1-4 and FIGS. 12 and 13 across farm ground and will typically be pulled at between five and ten miles per hour. Crumbler baskets, such as crumbler basket 52 and 252 shown in FIGS. 5-11, will be pulled in a canted direction D1 or in an oppositely canted direction D2 as shown in FIGS. 7 and 11, while maintaining the orientation shown. Directions D1 and D2 should be understood as being parallel to the longitudinal centerline of the implement and therefore its direction of travel and also perpendicular to the transverse direction T of the implement. D0 represents a direction that is perpendicular to the axis of rotation of the crumbler basket. A conventional prior art crumbler basket would be pulled in direction D0, which would also be perpendicular to the axis of rotation of the crumbler basket, as indicated in FIGS. 7 and 11. When, for example, a crumbler basket such as crumbler basket 52 or crumbler basket 252 shown in FIGS. 7 and 11 is pulled in a canted direction D1 or D2, the crumbler basket rolls but must also be pushed in a transverse direction. In other words, the implement must apply a pulling force in order to pull the crumbler basket and the implement must also apply a side force to crumbler basket to force it to travel in direction D1 or D2. In the case of direction D1, the side force applied by the implement pushes from left to right on the crumbler basket and in the case of direction D2, the side force pushes from right to left on the crumbler basket. How is such a side force transferred to the soil by splines 80 or 280? In the case of a crumbler basket 52 or 252 being pulled in direction D1, splines 80 (or 280), when making contact with the soil, will tend to urge soil, debris, and plant material such as weeds from the left to the right, and thus will push material to the right. And, in the case of a crumbler basket 52 or 252 being pulled in direction D2, splines 80 (or 280), when making contact with the soil, will tend to urge soil, debris, and plant material such as weeds from the right to the left, and thus will push material to the left. This sideways urging of soil, debris and weed plant material increases the crumber basket's effectiveness for displacing and disrupting weeds and also to smooth soil. The skilled reader will further appreciate that if the end plates of the present crumbler baskets are not fashioned to have to diameters that are significantly smaller than the overall diameter of the baskets, then the endplates will act as discs that are being dragged through the soil at a canted angle and would therefore leave furrows and ridges behind them.

Accordingly, the present crumbler baskets when employed in a pattern as attachment to an implement as described above, provides an improved mechanical method for smoothing soil as well as disrupting and killing weeds. Those skilled in the art may mount sets of crumbler basket assemblies having a general design similar to crumbler basket assemblies 42 and 242 shown in FIGS. 5-11 to implements as shown in FIGS. 3 and 4 and FIGS. 12 and 13, and pull such implements with such sets of crumbler baskets over farm ground in order to smooth soil and disrupt and destroy weeds. As noted above, such crumbler baskets, when deployed in canted orientations as described above, are uniquely and especially effective for disrupting and destroying weeds.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A crumbler basket implement, comprising:
(a) a frame that includes a plurality of side by side segments that are supported by wheels and interconnected at joints adapted for allowing the segments to pivot in relation to each other in order to accommodate variations ground elevation from side to side,
(b) a plurality of crumbler basket assemblies, each crumbler basket assembly including: (i) opposite end plates having a first diameter, (ii) a plurality of elongated spline members each having symmetrically inwardly directed ends that are each fixed to one of the opposite end plates, the spline members defining an elongated cylindrical cage having an outside second diameter that is substantially larger than the first diameter of the end plates, (iii) a yoke that spans around the crumbler basket that rotatably engages each end plate and which presents a spanning member that is adapted for mounting to the implement frame, and,
(c) the plurality of crumbler baskets being arranged in at least one parallel pattern and each crumbler basket being canted at an acute angle with respect to the transverse direction of the implement, the crumbler baskets being arranged such that the forward leading end of a basket is situated to be in front of the rearward trailing end of the adjacent basket.

2. The implement of claim one, wherein:
approximately half of the crumbler baskets are oriented with the right end of the crumbler basket forward of the left end of the crumbler basket and the remaining crumbler baskets are oriented with the left end of the crumbler basket forward of the right end of the crumbler basket.

3. The implement of claim 2, wherein:
the angle of orientation of the crumbler basket with respect to the transverse direction of implement is between 5 and 35 degrees.

4. The implement of claim 2, wherein:
the angle of orientation of the crumbler basket with respect to the transverse direction of implement is between 20 and 30 degrees.
